(19) United States
(12) Patent Application Publication
(10) Pub. No.: US 2011/0115844 A1
(43) Pub. Date: May 19, 2011

(54) PRINTING DEVICE

(76) Inventor: Chizuo Ozawa, Nagano (JP)

(21) Appl. No.: 12/737,110

(22) PCT Filed: Jun. 2, 2009
(86) PCT No.: PCT/JP2009/002463

§ 371 Date: Jan. 18, 2011

(30) Foreign Application Priority Data
Jun. 24, 2008 (JP) 2008-163912

(51) Int. Cl. B41J 2/165

(52) U.S. Cl. 347/28

(57) ABSTRACT

A printing device (1) is provided with an ink circulation passage (4) for circulating, via an inkjet head (2), pigmented ink stored in an ink tank (3). A bypass passage (5) which bypasses the inkjet head (2) is connected to the ink circulation passage (4). When printing is performed, ink is circulated via an ink damper (10) of the inkjet head (2), and when the device is on print standby, the pigment particles in the pigmented ink are prevented from settling in the ink passage by circulation of the ink via the bypass passage (5). When the device is on print standby, cleaning liquid supply passages (13, 14) are opened and a cleaning pump (19b) is driven so that the cleaning liquid is sucked out from a cleaning liquid tank (12) and made to pass through nozzles in the inkjet head (2), whereby the pigmented ink inside the inkjet head (2) is cleaned.

### TECHNICAL FIELD

The present invention relates to a printing device which prints by discharging pigmented ink or another settling ink from nozzles of an inkjet head.

### BACKGROUND ART

In an inkjet printing device which uses pigmented ink or another settling ink, when the device is left standing without printing for a long period of time, the pigment particles in the ink solution settle and ink clogging occurs in the ink tank, the ink supply route leading from the ink tank to the inkjet head, and other areas. Problems arise as a result, such as the ink can no longer be discharged from the inkjet head, and the concentration of the pigment particles changes in the ink solution supplied to the inkjet head, compromising printing quality.

Patent Document 1 proposes an inkjet recording device which has an ink supply passage capable of circulating ink to an ink supply tank without passing the ink through an inkjet head, in order to prevent problems caused by settling of the pigment particles in the ink solution. In this inkjet recording device, an ink-circulating action is performed even no ink is being supplied to the inkjet head, in which the ink in the tank is sucked up from one end of the ink supply passage, caused to flow into the ink supply passage, and returned back to the tank from the other end of the ink supply passage, whereby settling of the pigment particles is prevented in the ink supply passage or the tank. A magnetic stirrer is installed in the tank for supplying ink, and the ink is stirred, whereby settling of the pigment particles in the tank can be prevented.

### PRIOR ART DOCUMENTS

### Patent Documents

[Patent Document 1] Japanese Laid-open Patent Application No. 2008-55646

### DISCLOSURE OF THE INVENTION

### Problems the Invention is Intended to Solve

In the configuration of Patent Document 1, although the settling of pigment particles can be prevented in the ink supply tank and the portion of the ink supply route constituting the circulation passage, settling of the pigment particles cannot be prevented in the inkjet head, the manifold connecting the inkjet head and the ink supply passage, and other areas. To prevent the settling of pigment particles in the inkjet head, a cleaning action can be performed in which ink is periodically discharged from the nozzles of the inkjet head, for example. However, when such a cleaning action is performed, a greater amount of ink is needlessly consumed and running costs increase.

An object of the present invention is to propose a printing device whereby settling of the pigment particles in an ink solution can be prevented in an inkjet head or an ink supply route without increasing the amount of ink consumed.

### Means for Solving these Problems

To solve the problems described above, the printing device of the present invention is characterized in comprising:

an inkjet head;

an ink storage unit;

an ink circulation passage for circulating ink stored in the ink storage unit through an ink damper communicating with the inkjet head;

an ink circulation pump for circulating ink through the ink circulation passage;

a bypass passage communicating a branching position upstream of the ink damper in the ink circulation passage with a merging position downstream;

passage switching means for switching the route of ink circulating through the ink circulation passage between a route passing through the ink damper and a route passing through the bypass passage;

a cleaning liquid storage unit;

a cleaning liquid supply passage, one end communicating with the cleaning liquid storage unit and the other end communicating with the passage portion between the branching position and the merging position in the ink circulation passage;

passage opening-closing means for opening and closing the cleaning liquid supply passage; and

a cleaning pump for sucking ink or cleaning liquid out of the nozzles of the inkjet head.

For the passage switching means, a first switching valve disposed in the branching position and a second switching valve disposed in the merging position can be used. In this case, the first switching valve is a three-way switching valve, and the three ports thereof preferably respectively communicate with a branching position upstream passage of the ink circulation passage, a branching position downstream passage, and an upstream end of the bypass passage, which are located in the branching position. Similarly, the second switching valve is a three-way valve, and the three ports thereof preferably respectively communicate with a merging position upstream passage of the ink circulation passage, a merging position downstream passage, and a downstream end of the bypass passage, which are located in the merging position.

The following action is preferably performed by control means for controlling the ink circulation pump, the passage switching means, the passage opening-closing means, and the cleaning pump.

Specifically, the control means drives the ink circulation pump at predetermined intervals in order to circulate the ink at predetermined intervals. During printing, the control means switches the route of ink circulating through the ink circulation passage to a route passing through the ink damper and switches the cleaning liquid supply passage to a closed state. When a print standby state continues for a predetermined time or longer, the control means switches the route of ink circulating through the ink circulation passage to a route passing through the bypass passage, opens the cleaning liquid supply passage, and drives the cleaning pump to suck the nozzles of the inkjet head.

Next, the printing device of the present invention preferably has stirring means for stirring the ink stored in the ink storage unit. As an alternative, the printing device may have vibrating means for imparting vibration to the ink storage unit to stir the ink in the ink storage unit.

### Effects of the Invention

In the printing device of the present invention, the ink circulation passage is provided with the bypass passage which bypasses the inkjet head and circulates ink, and ink from the ink storage unit can be circulated by the passage switching means through either a passage through an ink damper of the inkjet head or the bypass passage which bypasses the ink damper of the inkjet head. Consequently, ink can be circulated through the ink circulation passage both when printing is being performed and when printing is not being performed. Therefore, the settling of ink in the ink circulation passage can be prevented during both printing and print standby.

During standby mode, the inkjet head can be switched away from the ink circulation passage. By creating this state, supplying cleaning liquid to the inkjet head via the cleaning liquid supply passage, and sucking the supplied cleaning liquid out from the nozzles, the ink remaining in the inkjet head can be washed out. As a result, it is possible without consuming ink to maintain the interior of the inkjet head in a proper state in which pigment particles do not settle.

### BRIEF DESCRIPTION OF THE DRAWINGS

FIG. 1 is a schematic structural drawing of a printing device according to Embodiment 1 to which the present invention is applied;

FIG. 2 is a schematic structural drawing of a printing device according to Embodiment 2;

FIG. 3 is a schematic structural drawing of a printing device according to Embodiment 3; and

FIG. 4 is a schematic structural drawing of a printing device according to Embodiment 4.

### MODE FOR CARRYING OUT THE INVENTION

Embodiments of the printing device to which the present invention is applied are described hereinbelow with reference to the drawings.

### Embodiment 1

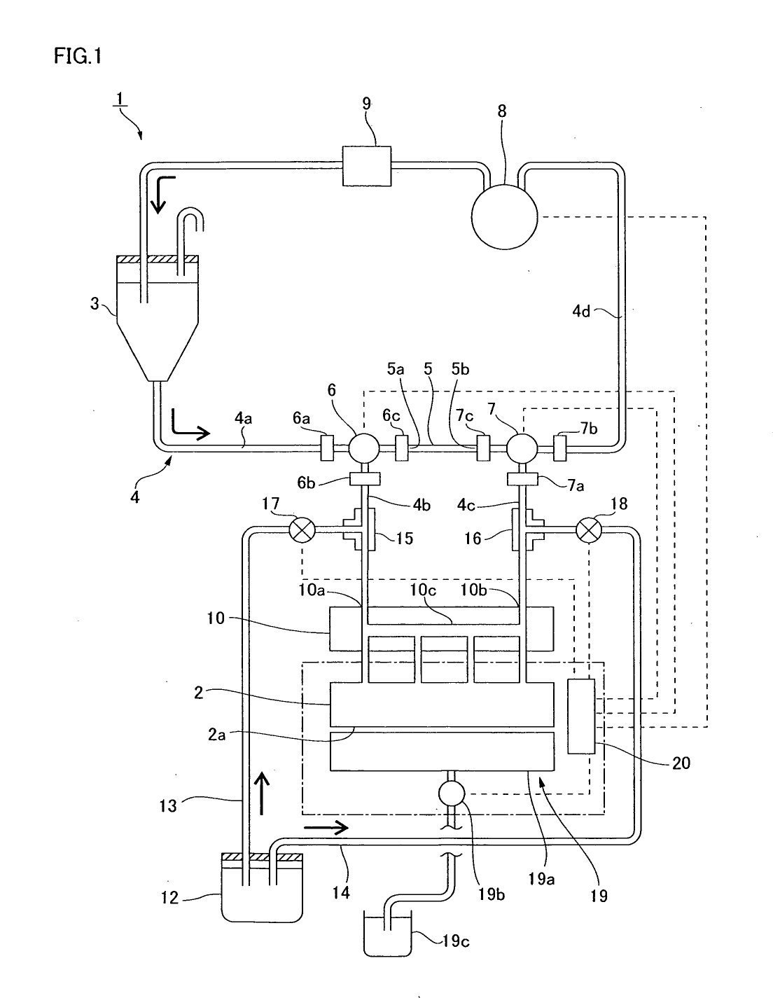

FIG. 1 is a schematic structural drawing of the printing device according to Embodiment 1 to which the present invention is applied. A printing device 1 is provided with an inkjet head 2 that prints with white ink for textiles or another pigmented ink, an ink tank 3 for storing pigmented ink to be supplied to the inkjet head 2, and an ink circulation passage 4 for circulating ink via an ink damper 10 communicating with the inkjet head 2. The upstream end of the ink circulation passage 4 is connected to the bottom of the ink tank 3, and the downstream end of the ink circulation passage 4 is connected to the top of the ink tank 3.

A bypass passage 5 which branches off from an area (branching position) upstream of the inkjet head 2 and merges at an area (merging position) downstream of the inkjet head 2 is connected to the ink circulation passage 4. The bypass passage 5 is connected to the ink circulation passage 4 at the branching position via a three-way switching valve 6, and is connected to the ink circulation passage 4 at the merging position via a three-way switching valve 7. An ink circulation pump 8 and a filter 9 are disposed in the route leading from the merging position of the ink circulation passage 4 to the ink tank 3.

At the branching position, the three ports 6a, 6b, 6c of the three-way switching valve 6 are respectively communicated with a branching position upstream passage 4a of the ink circulation passage 4, a branching position downstream passage 4b, and an upstream end 5a of the bypass passage 5. The three-way switching valve 6 can be switched between a first switched position in which the ports 6a, 6b are communicated, and a second switched position in which the ports 6a, 6b are communicated. At the merging position, the three ports 7a, 7b, 7c of the three-way switching valve 7 are respectively communicated with a merging position upstream passage 4c of the ink circulation passage 4, a merging position downstream passage 4d, and a downstream end 5b of the bypass passage 5. The three-way switching valve 7 can be switched between a first switched position in which the ports 7a, 7b are communicated, and a second switched position in which the ports 7b, 7c are communicated.

The ink damper 10 (ink manifold) communicating with the inkjet head 2 is connected between the branching position downstream passage 4b and the merging position upstream passage 4c in the ink circulation passage 4. Ink is supplied to the inkjet head 2 via the ink damper 10. An inflow port 10a of the ink damper 10 is connected to the branching position downstream passage 4b of the ink circulation passage 4, and an outflow port 10b is connected to the merging position upstream passage 4c of the ink circulation passage 4. An ink chamber 10c communicating with the inflow port 10a and the outflow port 10b is formed inside the ink damper 10, and this ink chamber 10c is communicated with an ink chamber (not shown) inside the inkjet head 2 via a damper sheet or another damper mechanism. The ink chamber in the inkjet head 2 is communicated with nozzles (not shown).

Next, the printing device 1 is provided with a cleaning tank 12 which stores a cleaning liquid for cleaning the interior of the inkjet head 2. Two cleaning liquid supply passages 13, 14 are connected to the cleaning tank 12. The cleaning liquid supply passage 13 is connected via a Y-shaped joint 15 to the branching position downstream passage 4b in the ink circulation passage 4. An on-off valve 17 is installed at a position in proximity to the Y-shaped joint 15 in the cleaning liquid supply passage 13. The other cleaning liquid supply passage 14 is connected via a Y-shaped joint 16 to the merging position upstream passage 4c in the ink circulation passage 4. Similarly, an on-off valve 18 is installed in a position in proximity to the Y-shaped joint 16 in the cleaning liquid supply passage 14.

A cleaning device 19 is disposed facing a nozzle surface 2a of the inkjet head 2. The cleaning device 19 performs a cleaning action for sucking the nozzles of the inkjet head 2 and sucking out the ink, cleaning liquid, or other liquid in the nozzles. The cleaning device 19 is provided with a capping mechanism 19a capable of moving a position of covering the nozzle surface of the inkjet head 2, and a cleaning pump 19b capable of sucking the space covered by the capping mechanism 19a. The discharge side of the cleaning pump 19b is connected to a waste liquid tank 19c.

A controller 20 of the printing device 1 includes a CPU or other signal processor, a storage unit for storing programs or various data for control, and an input unit whereby commands from the exterior are inputted; and performs various controls on the basis of the print commands or control commands from the exterior. Specifically, the controller 20 drives the inkjet head 2 and causes the printing action to be performed based on the print commands from the exterior. A control signal is sent to the ink circulation pump in conjunction with the printing action, and ink is circulated through the ink circulation passage 4. Furthermore, either in conjunction with the printing action or based on a cleaning command from the exterior, a control signal is sent to the cleaning device 19 and the capping mechanism 19a and cleaning pump 19b are activated. Control signals are also sent to the three-way switching valves 6, 7 and the on-off valves 17, 18, the three-way switching valves 6, 7 are switched, and the on-off valves 17, 18 are turned on or off. The three-way switching valves 6, 7 and the on-off valves 17, 18 may also be operated manually without being controlled by the controller 20 of the printing device 1, or they may be controlled via another controller.

### (Action of Circulating Ink and Cleaning Liquid)

With the printing device 1 of this configuration, the ink circulation pump 8 is driven periodically and the ink-circulating action is performed periodically via the ink circulation passage 4 during both printing and standby.

First, during printing, the controller 20 closes the on-off valves 17, 18, shutting off the cleaning liquid supply passages 13, 14. The three-way switching valves 6, 7 are set to the first switched position, forming an ink circulation route through the ink damper 10 of the inkjet head 2. When the ink circulation pump 8 is driven in this state, the ink of the ink tank 3 flows through the ink damper 10 of the inkjet head 2. The nozzles of the inkjet head 2 are supplied with ink via the ink damper 10. When the nozzles are driven, ink droplets are discharged from the nozzles onto a recording medium (not shown).

Next, when the print standby state has continued for a predetermined time period or longer, the controller 20 switches the three-way switching valves 6, 7 to the second switched position, forming a circulation route through the bypass passage 5 which bypasses the inkjet head 2. When the ink circulation pump 8 is driven in this state, the ink circulates through the bypass passage 5, and the pigment particles in the ink are therefore prevented from settling and causing ink blockage in the passage in which the ink is circulating, even while printing is not being performed.

In this state, the controller 20 opens the on-off valves 17, 18, causing the cleaning liquid supply passages 13, 14 to be communicated with the ink damper 10 side of the inkjet head 2. The nozzle surface of the inkjet head 2 is covered by the capping mechanism 19a of the cleaning device 19, creating an airtight space around the periphery of the nozzles, and the cleaning pump 19b is activated. Due to the suction force of the cleaning pump 19b, the cleaning liquid in the cleaning tank 12 flows through the cleaning liquid supply passages 13, 14 and the ink damper 10 into the inkjet head 2, and the ink is sucked out from the nozzles and expelled into the waste liquid tank 19c. As a result, these passages, the ink chamber in the inkjet head 2, the nozzles, and other components are cleaned. The ink remaining in these passages and in the inkjet head 2 can thereby be washed out.

The timing and cleaning time period during which cleaning of the inkjet head 2 interior by the cleaning liquid is performed can be appropriately set. For example, when the controller 20 has detected by an internal timer that the printing action has not been performed for a predetermined time period or longer, the controller 20 may cause the cleaning liquid to flow and perform cleaning continuously for a predetermined time period, and the controller 20 may then prevent ink from being supplied into the inkjet head 2 until the next printing begins. Otherwise, ink may be supplied again to the nozzles of the inkjet head 2 after cleaning, enabling printing to be performed, and the cleaning action and ink supply action may thereafter be repeatedly performed at intervals of a predetermined time period or longer. The same applies to the timing of the circulating action of ink through the bypass passage. The ink-circulating action may also be performed based on an ink circulation command from the exterior.

Instead of causing the cleaning liquid to flow by the suction force of the cleaning pump 19b, another possibility is to provide the cleaning liquid supply passages 13, 14 with circulation pumps and cause the cleaning liquid to circulate.

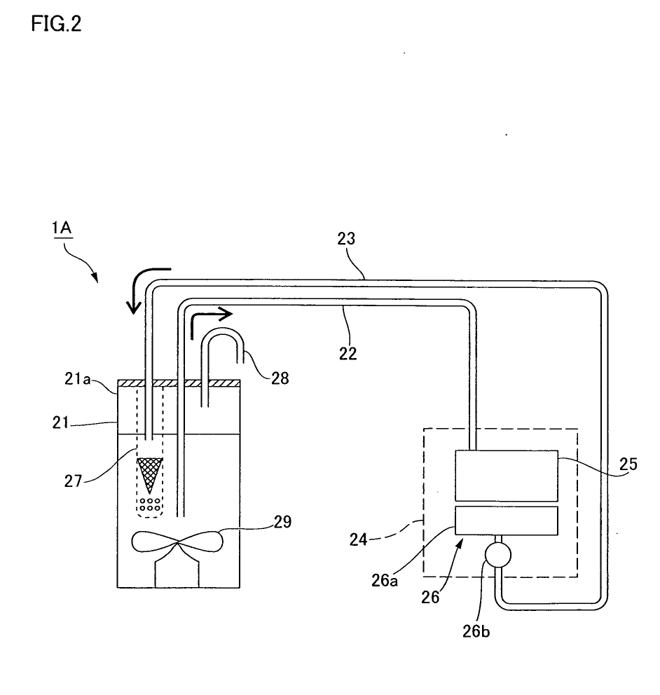

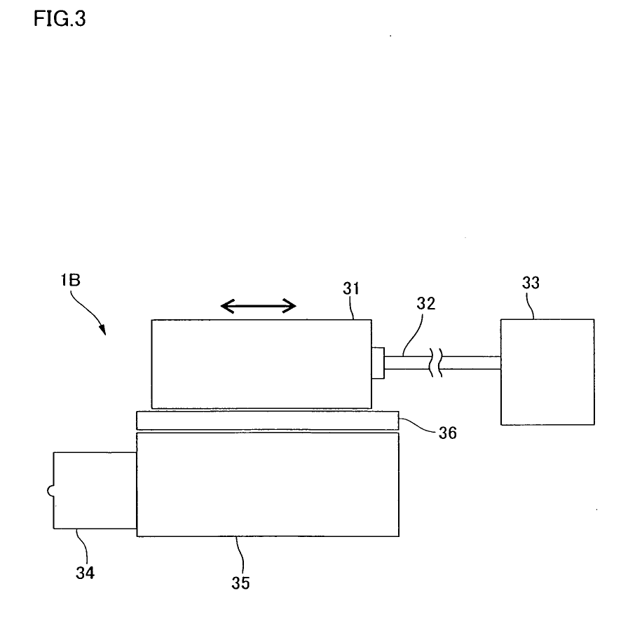

If a stirrer or other stirring means is provided in the ink tank 3 and the interior of the ink tank 3 is stirred, the concentration of ink flowing out to the ink circulation passage 4 can be made uniform, and it is therefore possible to prevent unsatisfactory printing caused by changes in the ink concentration supplied to the inkjet head 2 due to settling of the pigment particles. For example, the mechanisms shown in Embodiments 2 and 3 (FIGS. 2 and 3) described hereinafter can be used.

### Embodiment 2

FIG. 2 is a schematic structural drawing of the printing device according to Embodiment 2 to which the present invention is applied. The printing device 1A is provided with an ink tank 21 for storing white ink for textiles or other pigmented ink, an ink supply passage 22 and an ink recovery passage 23 communicating with the inside of the ink tank 21, and an inkjet printer 24 to which the ink supply passage 22 and the ink recovery passage 23 are connected.

The inkjet printer 24 is provided with an inkjet head 25 and a cleaning device 26 configured in the same manner as the inkjet head 2 and the cleaning device 19 in Embodiment 1. The ink supply passage 22 is connected to the inkjet head 25 via a manifold (not shown), and ink is supplied into the inkjet head 25 from this ink supply passage 22. The ink recovery passage 23 is connected to a capping mechanism 26a of the cleaning device 26, and when a cleaning pump 26b of the cleaning device 26 is activated, the ink sucked from the nozzles of the inkjet head 25 can be returned from the ink recovery passage 23 to the ink tank 21.

Inside the ink tank 21, a cylinder 27 is attached extending from a lid 21a of the ink tank 21 toward the bottom. The bottom portion of the cylinder 27 is closed off and sits beneath the liquid surface of the ink. The cylinder 27 is formed from a stainless steel mesh material, and the roughness of the pores in the steel mesh portion is about 60 to 80 meshes when the number of mesh openings is one mesh per square inch. The ink recovery passage 23 is passed through the lid 21a and inserted into the interior of the cylinder 27, and the bottom end thereof extends beneath the liquid surface of the ink inside the cylinder 27. The ink supply passage 22 passes through the lid 21a of the ink tank 21 at a different position than the ink recovery passage 23, and the bottom end thereof extends beneath the liquid surface of the ink in the ink tank 21.

A deaeration tube 28 which passes through the lid 21a is installed in the ink tank 21, and the bottom end of the deaeration tube 28 opens over the liquid surface of the ink. A stirrer 29 is installed on the bottom of the ink tank 21, and this stirrer 29 is caused to rotate by a motor or another drive source (not shown), whereby the ink in the ink tank 21 can be stirred.

A pump and filter (not shown) are installed in the ink supply passage 22. The ink in the ink tank 21 can be fed out to the inkjet head 25 by the pump, and impurities flowing through the ink supply passage can be filtered out by the filter.

Next, the circulation of ink in the printing device 1A is described. When printing is performed by the inkjet head 25, the controller of the inkjet printer 24 activates the pump of the ink supply passage 22, supplies ink to the inkjet head 25, and performs printing. When printing continues to go unperformed for a predetermined time period or longer, the controller of the inkjet printer 24 uses the capping mechanism 26a of the cleaning device 26 to close off the nozzle surface of the inkjet head 25 and uses the cleaning pump 26b to suck out the nozzles of the inkjet head 25. Ink can thereby be made to flow to the ink supply passage 22 and to the liquid chamber or nozzles in the inkjet head 25. The sucked-out ink can also be made to flow to the ink recovery passage 23 and returned to the ink tank 21.

The ink recovered in the ink tank 21 from the ink recovery passage 23 is ejected into the cylinder 27. The ink flowing into the ink recovery passage 23 from the cleaning device 26 contains air bubbles, but passes through the thin mesh of the cylinder 27 when flowing into the ink tank 21, at which time the air bubbles are removed. The ink recovered in the ink tank 21 thereby no longer contains air bubbles. Consequently, it is possible to prevent unsatisfactory printing caused by ink containing air bubbles being re-circulated and supplied to the inkjet head 25.

As described above, in the printing device 1A of Embodiment 2, since ink can be made to flow through the ink supply passage 22 and the ink recovery passage 23 to the inkjet head 25 even while printing is not being performed, the pigment particles in the ink solution in the inkjet head 25, the ink supply passage 22, and the ink recovery passage 23 can be prevented from settling. Using the stirrer 29 to stir the interior of the ink tank 21 also allows the pigment particles in the ink tank 21 to be prevented from settling. Consequently, it is possible to prevent unsatisfactory printing and other problems from occurring due to changes in the ink concentration supplied to the inkjet head 25.

### Embodiment 3

FIG. 3 is a schematic structural drawing showing the printing device according to Embodiment 3 to which the present invention is applied. The printing device of Embodiment 3 is designed to be capable of preventing the pigment particles in the ink tank from settling.

A printing device 1B is provided with an ink tank 31 for storing white ink for textiles or other pigmented ink, an ink supply channel 32 communicating with the interior of the ink tank 31, and an inkjet printer 33 connected to the ink supply channel 32. The inkjet printer 33 has a conventional configuration provided with an inkjet head.

The ink tank 31 is formed from a bag made of aluminum, and after ink is sealed inside the interior, the interior is deaerated and made to contain no air. The printing device 1B is provided with a motor 34, a cam mechanism 35 for converting the rotation of an output shaft of the motor 34 into linear reciprocating movement, and a mobile stand 36 which is installed on the cam mechanism 35 and is supported so as to be capable of sliding in a linear direction by a guide mechanism or the like (not shown), wherein the ink tank 31 is set on top of the mobile stand 36.

The controller of the inkjet printer 33 continues to not perform printing for a predetermined time period, the inkjet printer 33 sends a drive signal to the motor 34, causing the motor 34 to rotate and the mobile stand 36 to vibrate forward and backward, whereby the ink tank 31 is vibrated forward and backward. When this happens, the ink in the ink tank 31 is stirred by the vibration and the pigment particles in the ink solution are prevented from settling; therefore, the concentration of ink supplied from the ink supply channel 32 to the inkjet printer 33 does not decrease and unsatisfactory printing or the like does not occur. Thick ink containing many pigment particles will not be supplied to the inkjet printer 33 when the amount of remaining ink is low, nor will the ink passages or nozzles become clogged.

The cam mechanism 35 is not limited to one that converts rotational movement to linear reciprocating movement; it may be one that can convert the rotation of the motor 34 into movement that does not allow the pigment particles in the ink tank 31 to settle and can vibrate the ink tank 31. A vibrating motor or the like may also be used instead of the motor 34 and the cam mechanism 35.

### Embodiment 4

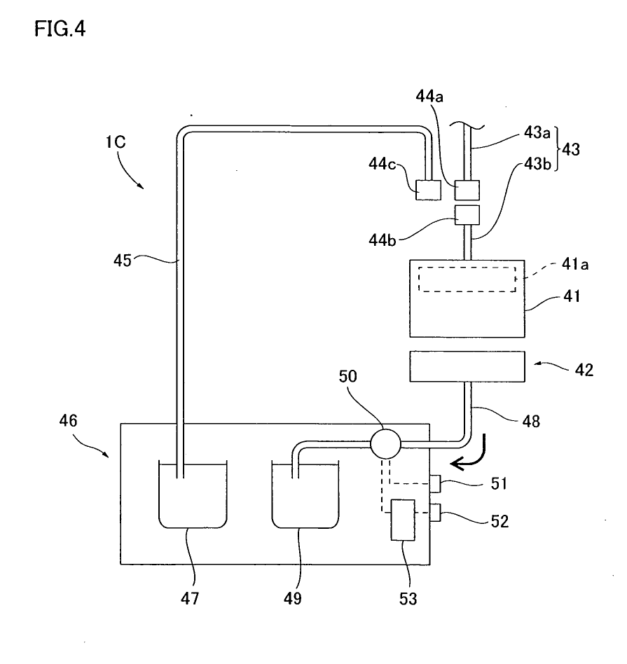

FIG. 4 is a schematic structural drawing showing the printing device according to Embodiment 4 to which the present invention is applied. The printing device according to Embodiment 4 comprises a configuration in which a cleaning liquid supply passage of a cleaning unit can be connected to an ink supply route of an inkjet head.

A printing device 1C is provided with an inkjet head 41 and a cleaning device 42 configured in the same manner as the inkjet head 2 and the cleaning device 19 in Embodiment 1. The inkjet head 41 is connected to an ink supply passage 43, and settling pigmented ink is supplied from an ink tank (not shown) to the inkjet head 41 via the ink supply passage 43. A pressure damper 41a for discharging ink is provided in the inkjet head 41 in the portion connected with the ink supply passage 43.

The ink supply passage 43 is provided with an upstream passage 43a on the side near the ink tank and a downstream passage 43b on the side near the inkjet head. The upstream passage 43a and the downstream passage 43b are connected in a detachable manner by connectors 44a, 44b attached at the respective connecting ends.

A connector 44c attached to the end of a cleaning liquid supply passage 45 is designed to be detachably connectable to the connector 44b of the downstream passage 43b. The cleaning liquid supply passage 45 is connected to a cleaning tank 47 in a cleaning unit 46, and a cleaning liquid is stored in the cleaning tank 47. The cleaning liquid supplied from the cleaning liquid supply passage 45 to the inkjet head 41 is passed through a cleaning liquid expulsion passage 48 of the cleaning device 42 and expelled to a waste liquid tank 49.

A cleaning pump 50 of the cleaning device 42 is installed in the cleaning liquid expulsion passage 48. When a start switch 52 of the cleaning device 42 is pressed in a state in which a power source switch 51 has been operated to apply the power source of the cleaning unit 46, the cleaning pump 50 activates for a time period set in a timer 53, and the cleaning liquid is supplied from the cleaning tank 47 to the inkjet head 41. The cleaning liquid flows into the inkjet head 41 and washes out sediment of the pigment particles contained in the ink solution remaining in the passages, ink chamber, and other components in the inkjet head 41.

As described above, the printing device 1C integrates the cleaning device 42, the cleaning tank 47, the waste liquid tank 49, and other components, and comprises the cleaning unit 46 which is capable of causing the cleaning liquid to flow through the inkjet head 41 via the cleaning liquid supply passage 45 and the cleaning liquid expulsion passage 48. Since this cleaning unit 46 can be separated from the printer portion of the printing device 1C that comprises the inkjet head 41, the cleaning unit 46 is mounted to the printer portion only when necessary and is also capable of cleaning ink routes in the printing device 1C that are susceptible to ink clogging.

By setting a cleaning schedule in the timer 53 in advance, the cleaning pump 50 can be automatically activated and the inkjet head 41 and ink passages can be cleaned with the desired timing. This timer 53 may also be controlled by a controller for controlling the printing action of the inkjet head 41 and the cleaning action may be performed in conjunction with the printing action of the inkjet head 41, or the cleaning action may be performed when printing has continued to go unperformed for a predetermined time period or longer.

An ink tank or ink bottle for supplying pigmented ink or another ink may be replaced with a tank or bottle filled with cleaning liquid, and in this state, the ink routes through which ink flows and the passages or ink chamber in the inkjet head 41 may be cleaned by activating the cleaning pump 50. In this case, there is no need to connect the connector 44b to the connector 44c of the cleaning liquid supply passage 45. If the ink tank or ink bottle is emptied and filled with the cleaning liquid and cleaned, all of the ink routes including the interior of the ink tank or ink bottle can be cleaned. In cases in which a plurality of ink tanks or ink bottles are provided for color printing, some may be replaced by ink tanks or ink bottles designated for the cleaning liquid.

### DESCRIPTION OF SYMBOLS

1, 1A, 1B, 1C Printing device
2 Inkjet head
2a Nozzle surface
3 Ink tank
4 Ink circulation passage
4a Branching position upstream passage
4b Branching position downstream passage
4c Merging position upstream passage
4d Merging position downstream passage
5 Bypass passage
5a Upstream end
5b Downstream end
6 Three-way switching valve
6a Port
7 Three-way switching valve
7a Port
8 Ink circulation pump
9 Filter
10 Ink damper
10a Inflow port
10b Outflow port
10c Ink chamber
12 Cleaning tank
13, 14 Cleaning liquid supply passages
15, 16 Y-shaped joints
17, 18 On-off valves
19 Cleaning device
19a Capping mechanism
19b Cleaning pump
19c Waste liquid tank
20 Controller
21 Ink tank
21a Lid
22 Ink supply passage
23 Ink recovery passage
24 Inkjet printer
25 Inkjet head
26 Cleaning device
26a Capping mechanism
26b Cleaning pump
27 Cylinder
28 Deaeration tube
29 Stirrer
31 Ink tank
32 Ink supply channel
33 Inkjet printer
34 Motor
35 Cam mechanism
36 Mobile stand
41 Inkjet head
41a Pressure damper
42 Cleaning device
43 Ink supply passage
43b Downstream passage
43a Upstream passage
44a-44c Connectors
45 Cleaning liquid supply passage
46 Cleaning unit
47 Cleaning tank
48 Cleaning liquid expulsion passage
49 Waste liquid tank
50 Cleaning pump
51 Power source switch
52 Start switch
53 Timer

1. A printing device characterized in comprising:
an inkjet head;
an ink storage unit;
an ink circulation passage for circulating ink stored in the ink storage unit through an ink damper communicating with the inkjet head;
an ink circulation pump for circulating ink through the ink circulation passage;
a bypass passage communicating a branching position upstream of the ink damper in the ink circulation passage with a merging position downstream;
passage switching means for switching a route of ink circulating through the ink circulation passage between a route passing through the ink damper and a route passing through the bypass passage;
a cleaning liquid storage unit;
a cleaning liquid supply passage, one end communicating with the cleaning liquid storage unit and the other end communicating with a passage portion between the branching position and the merging position in the ink circulation passage;
passage opening-closing means for opening and closing the cleaning liquid supply passage; and
a cleaning pump for sucking out ink or cleaning liquid out of the nozzles of the inkjet head.

2. The printing device according to claim 1, characterized in that:
the passage switching means has a first switching valve disposed in the branching position and a second switching valve disposed in the merging position;
the first switching valve is a three-way switching valve, three ports thereof respectively communicating with a branching position upstream passage portion of the ink circulation passage, a branching position downstream passage portion, and an upstream end of the bypass passage, which are located in the branching position; and
the second switching valve is a three-way valve, three ports thereof respectively communicating with a merging position upstream passage portion of the ink circulation passage, a merging position downstream passage portion, and a downstream end of the bypass passage, which are located in the merging position.

3. The printing device according to claim 1, characterized in having:
control means for controlling the ink circulation pump, the passage switching means, the passage opening-closing means, and the cleaning pump; wherein
the control means:
drives the ink circulation pump at predetermined intervals in order to circulate the ink at predetermined intervals;
switches the route of ink circulating through the ink circulation passage to a route passing through the ink damper and switches the cleaning liquid supply passage to a closed state during printing; and
when a print standby state continues for a predetermined time or longer, the control means switches the route of ink circulating through the ink circulation passage to a route passing through the bypass passage, opens the cleaning liquid supply passage, and drives the cleaning pump to suck out the nozzles of the inkjet head.

4. The printing device according to claim 1, characterized in having:
stirring means for stirring the ink stored in the ink storage unit.

5. The printing device according to claim 1, characterized in having:
vibrating means for imparting vibration to the ink storage unit to stir the ink in the ink storage unit.
